(19) United States
(12) Patent Application Publication
(10) Pub. No.: US 2021/0164282 A1
(43) Pub. Date: Jun. 3, 2021

(54) SPINDLE DRIVE FOR A CLOSURE ELEMENT OF A MOTOR VEHICLE

(71) Applicant: Brose Fahrzeugteile SE & Co. Kommanditgesellschaft, Bamberg, Bamberg (DE)

(72) Inventor: Matthias FISCHER, Itzgrund (DE)

(73) Assignee: Brose Fahrzeugteile SE & Co. Kommanditgesellschaft, Bamberg, Bamberg (DE)

(21) Appl. No.: 17/044,931

(22) PCT Filed: Feb. 15, 2019
(86) PCT No.: PCT/EP2019/053830

§ 371 Date: Nov. 3, 2020

(30) Foreign Application Priority Data
Apr. 4, 2018 (DE) 10 2018 002 905.1

(51) Int. Cl. E05F 15/622

(52) U.S. Cl. CPC E05F 15/622; E05Y 2201/10; E05Y 2201/702; E05Y 2900/546; E05Y 2201/70; E05Y 2800/28

(57) ABSTRACT

A spindle drive for a closure element of a motor vehicle, wherein a drive unit and a spindle/spindle nut transmission with the spindle/spindle nut transmission comprising a spindle and a spindle nut drivingly connected downstream of the drive unit and having a geometrical axis running in the axial direction for generating linear drive motions between a drive connection to the spindle and a drive connection to the nut. A tubular casing part may be provided that extends along the spindle axis and forms a receptacle for at least one of a plurality of components of the spindle drive axially mounted on the spindle drive connection and arranged in a row in the axial direction. When the spindle drive is mounted, the at least one component is interlockingly inset into the tubular casing part relative to the circumferential direction.

### CROSS-REFERENCE TO RELATED APPLICATIONS

This application is the U.S. National Phase of PCT Application No. PCT/EP2019/053830 filed Feb. 15, 2019, which claims priority to German Patent Application No. DE 10 2018 002 905.1 filed Apr. 4, 2018, the disclosures of which are hereby incorporated in their entirety by reference herein.

### TECHNICAL FIELD

The present disclosure relates to a spindle drive for a closure element of a motor vehicle and to a closure element arrangement of a motor vehicle with such a spindle drive.

### BACKGROUND

The spindle drive is used for the motorized adjustment of any closure elements of a motor vehicle. Such closure elements may be for example tailgates, rear opening hoods, engine hoods, load floors, but also doors, in particular sliding doors, of a motor vehicle. To this extent, the term “closure element” is in the present case to be understood in a broad sense.

### SUMMARY

A spindle drive may be used for the motorized adjustment of a tailgate of a motor vehicle. The spindle drive may have an electrical drive unit and a spindle/spindle nut transmission, configured downstream of the electrical drive unit in the power train and configured to translate linear drive movements for opening and closing the closure element between a spindle-side drive connection and a spindle-nut-side drive connection. The drive unit may have a tubular drive unit casing configured to receive a drive motor unit as well as an intermediate gear unit arranged downstream thereof in the power train. The drive motor unit may have an electrical drive motor and a drive motor casing and an intermediate transmission unit has transmission components and an intermediate transmission casing.

The drive motor of the drive motor unit transfers a torque by way of the transmission components of the intermediate transmission unit to the spindle of the spindle/spindle nut transmission. A corresponding rotation of the spindle relative to a spindle nut, the spindle nut threadedly engaged with the spindle and is held in a torsion tube of the spindle drive in a rotationally secured but axially movable manner thereby moving axially along the geometrical spindle axis of the spindle/spindle nut transmission. The spindle may be coupled by way of the intermediate transmission and the drive motor to the spindle-side drive connection of the spindle drive and the spindle nut may be coupled by way of a spindle guide tube, to which it may be connected in a rotationally secured manner, to the spindle-nut-side drive connection, the rotation of the spindle brings about a movement of the two drive connections in relation to one another in the axial direction.

The components of the drive unit and the intermediate transmission unit may be arranged loosely in the drive unit casing, which may be coupled in a rotationally secured manner to the spindle-side drive connection, and may be supported rotationally only by way of their mutual interfaces. There may be backlash configured between the individual component interfaces as a result of production-related tolerances, when there is a reversal of the direction of rotation the components including their casings may undergo a sudden shift. Since the individual backlashes of the component interfaces add to one another, this may amount to a considerable proportion of the overall backlash. If the overall backlash in the spindle drive is too great, this may cause noise during the operation of the spindle drive. It may also lead to undesired backlash between the closure element and the motor vehicle and may also cause a disturbance in the uniformity of the movement of the spindle drive.

The invention is based on the problem of designing and developing a spindle drive such that disturbing noises caused by backlash are avoided as much as possible.

The basic idea of minimizing disturbing noises caused by backlash by providing that components may be axially secured with respect to the spindle-side drive connection. Drive motor components that transfer torque to the spindle, are interlocked in the circumferential direction in a tubular casing part that is rotationally secured with respect to the spindle-side drive connection. The tubular casing part may be the drive unit casing connected to the assigned drive connection, in at least one of a rotationally secured and axially secured manner, and may receive at least one of the drive motor unit, the intermediate transmission unit and an additional component unit, for example with at least one of an overload coupling and a brake as the additional component. “Interlocked in the circumferential direction” means that a movement about the geometrical spindle axis is at least limited, and prevented, by an interlocking engagement between the respective component and said tubular casing part. In this way, the casing of the respective component is fixed in the circumferential direction on the tubular casing part, whereby the respective component casing does not itself undergo a sudden shift, or at least not significantly, and cause disturbing noises, when a change in the direction of rotation of the drive components occurs.

Specifically, in the mounted state of the spindle drive, the at least one component is inserted in the tubular casing part in an interlocking manner with respect to the circumferential direction. “In the mounted state” means that, at least after the spindle drive has been assembled into an operational state, there may be an interlocking engagement with respect to the circumferential direction. The components that are respectively connected to one another in an interlocking manner therefore do not necessarily have to have an interlocking engagement before the assembly of the spindle drive, but instead the interlocking engagement may also be introduced into the respective components during assembly. This may be performed for example by stamping, as soon as the respective component is inserted in the tubular casing part. Stamping of components and a casing part at one and the same time may automatically establish the interlocking engagement. It is also conceivable to provide the individual components, i.e. the tubular casing part on the one hand and the component respectively to be inserted therein on the other hand, with the interlocking engagement.

The interlocking engagement prevents twisting with respect to the circumferential direction when in the mounted state of the spindle drive. The interlocking engagement therefore connects the respective component and the tubular casing part to one another in a rotationally secured manner (backlash-free interlocking engagement).

The interlocking engagement may be provided in both circumferential directions. The interlocking engagement may prevent twisting in both circumferential directions. An axial interlocking engagement may also be provided.

Additionally, a formation and an assigned counter-formation interact with one another in an interlocking manner as a refinement of the interlocking engagement between the respective component and the tubular casing part. At least one of the formation and counter-formation may be an embossed formation, that is to say a formation that is produced by stamping. A separate molded body may also be connected to the tubular casing part in a rotationally secured manner and then provide the embossed formation. At least one of the tubular casing part and the respective component may also have, in cross section, an unround contour, which may provide an interlocking engagement in the circumferential direction. “In cross section” means in a section orthogonal to the axial direction.

In addition to the described interlocking engagement, a material bond, for example an adhesive bond, and/or a frictional engagement may also be provided between the respective component and the tubular casing part.

The component respectively held in an interlocking manner may make contact directly with the tubular casing part, the same materials making contact with one another here. It is also possible however that between the respective component and the tubular casing part there is provided a separate damping material, which additionally damps relative movements, and may prevent hard coupling engagement, between the interlocking engagement, that is to say for example between two beads.

It is also possible that a number of said components may be inserted in the tubular casing part in an interlocking manner as described herein. In this case, components adjacent to one another in the axial direction may be connected to one another, that is to say make contact with one another, and are fitted together.

As described herein, the various components can be inserted in the tubular casing part in an interlocking manner.

The tubular casing part may be the drive unit casing, which may also be the torsion tube, which holds the spindle nut in at least one of a rotationally secured and axially movable manner, and the input tube of the spindle drive, which together with an output tube forms a telescopic casing of the spindle drive.

In the case of the closure element arrangement as proposed, the same advantages are achieved as given above in connection with the spindle drive. Reference may be made to all of the statements made in relation to the spindle drive as proposed.

### BRIEF DESCRIPTION OF THE DRAWINGS

The invention is explained more specifically below on the basis of a drawing, which merely represents an exemplary embodiment and in which

FIG. 1 shows the rear region of a motor vehicle with a spindle drive as proposed for the gate arrangement there,

FIG. 2 shows a view of a detail of the spindle drive according to FIG. 1,

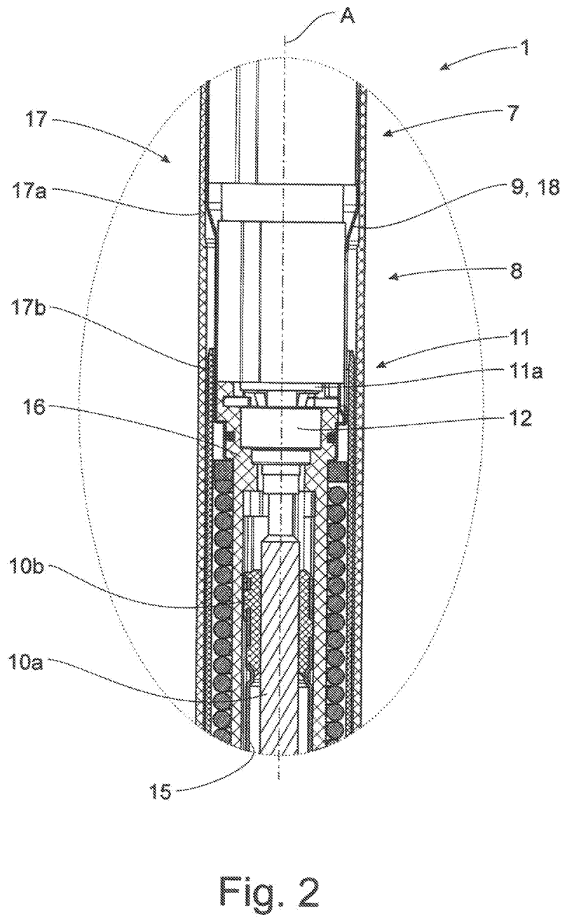

FIG. 3 shows part of the spindle drive according to FIG. 1 in the unmounted state and

FIG. 4 shows the part of the spindle drive according to FIG. 3 in the mounted state.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

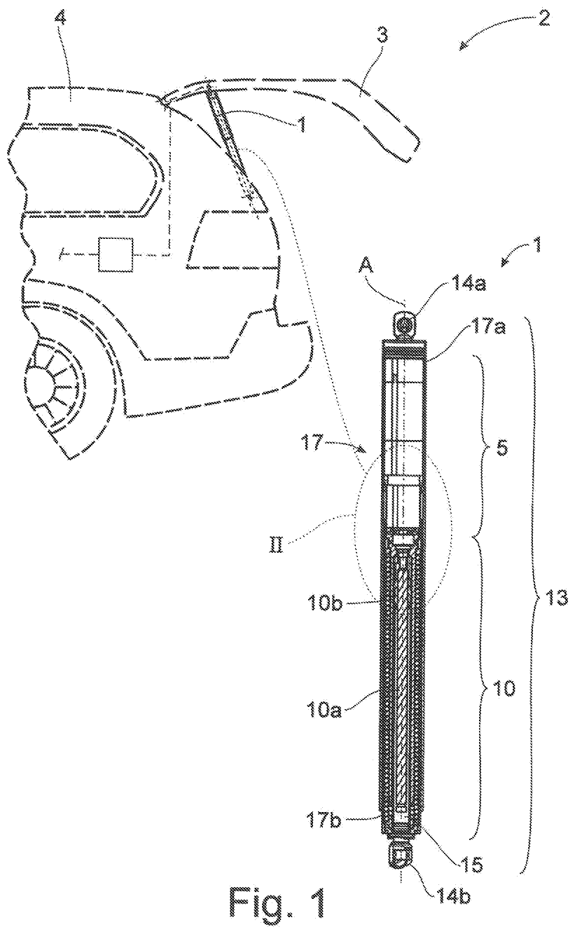

The spindle drive 1 as proposed is assigned to a closure element arrangement 2, in FIG. 1 for example a tailgate arrangement, which in turn is provided with a closure element 3, here a tailgate. The closure element arrangement 2 is assigned to a motor vehicle 4.

The closure element 3, may also be a different closure element of a motor vehicle 4, such as a rear opening hood, but also a sliding door. All of the statements made apply to other closure elements correspondingly.

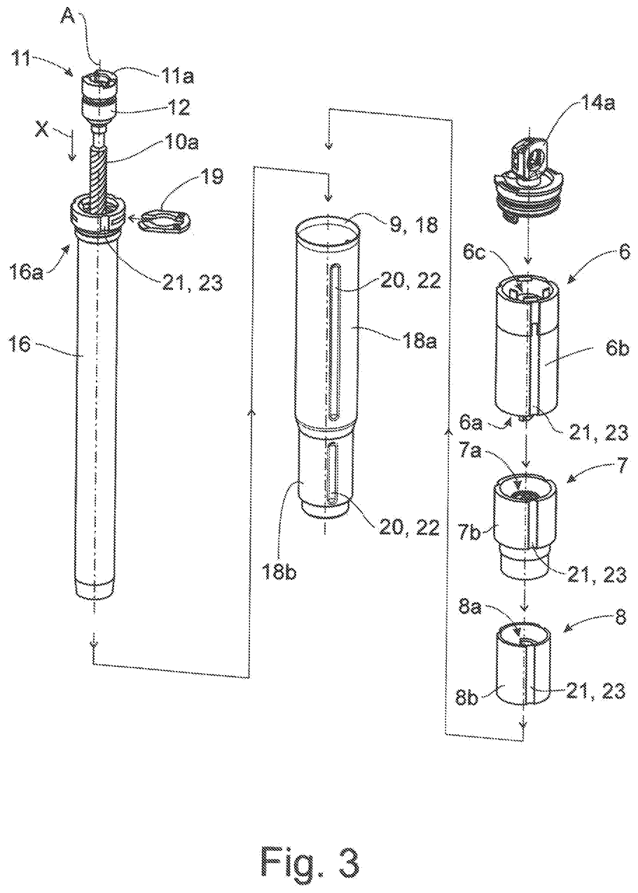

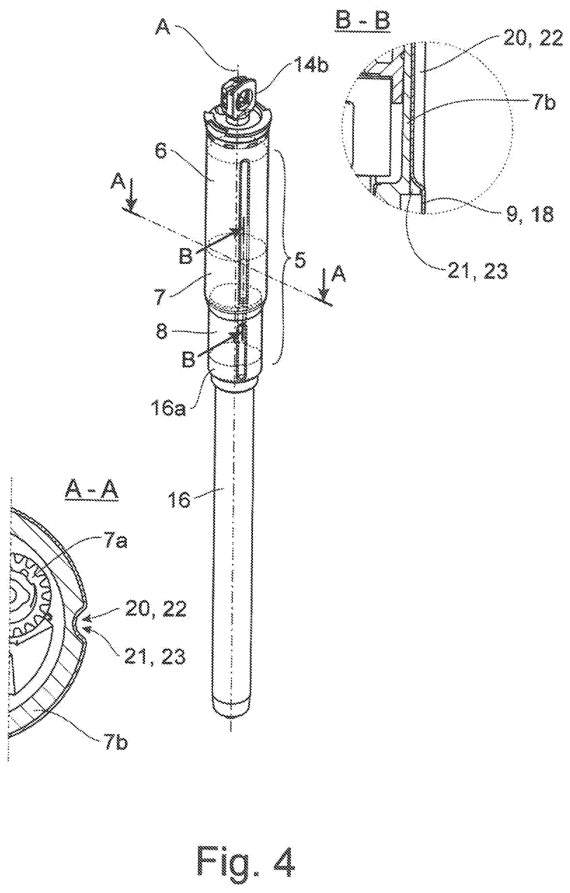

FIG. 1 shows that, for opening and closing the closure element 3, the spindle drive 1 of the closure element arrangement 2 of a motor vehicle 4 may have a drive unit 5. As FIGS. 3 and 4 show the drive unit 5 comprises a plurality of components 6, 7, 8, which are arranged one behind the other in the axial direction X and are connected to one another in a torque-transferring manner. The components 6, 7, 8, which are described more specifically later, may be mounted in an axially secured manner in a drive unit casing 9 of the drive unit 5.

Arranged downstream of the drive unit 5 in the power train is a spindle/spindle nut transmission 10 with a geometrical spindle axis A running in the axial direction X for producing linear drive movements in a first adjusting direction, which corresponds to an opening of the closure element 3, and in a second adjusting direction, which corresponds to a closing of the closure element 3.

The spindle/spindle nut transmission 10 of the spindle drive 1 may be provided with a rotating spindle 10a and a spindle nut 10b in screw engagement therewith. The spindle 10a may be coupled to the drive unit 5, here by way of a coupling arrangement 11.

The drive unit 5 and the spindle/spindle nut transmission 10 may be arranged in a power train 13, which extends from a spindle-side drive connection 14a to a spindle-nut-side drive connection 14b. The spindle-side drive connection 14a may be connected to the drive unit casing 9 here and preferably in an axially secured and/or rotationally secured manner, in particular may be crimped.

The spindle 10a may be guided in an axially movable manner in a spindle guide tube 15, the spindle guide tube 15 may be connected to the spindle nut 10b in a rotationally secured manner and may be coupled in a rotationally secured manner to the spindle-nut-side drive connection 14b. The spindle nut 10b may be guided in an axially movable and here and preferably rotationally secured manner in a torsion tube 16 of the spindle drive 1, the torsion tube 16 may be arranged radially around the spindle 10a and being coupled here in a rotationally secured and axially secured manner to the spindle-side drive connection 14a. In order to hold the spindle nut 10b in the torsion tube 16 in a rotationally secured manner, the torsion tube 16 may have one or more guide grooves (not represented), which may run parallel to the spindle axis A. Since the spindle nut 10b is held in a rotationally secured manner by the torsion tube 16, a rotational movement of the spindle l0a is converted by the spindle nut 10b into a translational movement of the spindle guide tube 15 coupled in a rotationally secured manner to the spindle nut 10b. Correspondingly, the two drive connections 14a, 14b can be adjusted in relation to one another in the axial direction X, i.e. along the spindle axis A.

The spindle drive 1 has a casing 17 comprising an input tube 17a and an output tube 17b telescopically guided therein, the input tube 17a may be coupled to the spindle-side drive connection 14a and the output tube 17b may be coupled to the spindle-nut-side drive connection 14b.

The drive unit casing 9, may be coupled to the spindle-side drive connection 14a in an axially secured manner, serves here for receiving a drive motor unit 6, an intermediate transmission unit 7 arranged downstream thereof in the power train and coupled thereto in a torque-transferring manner, as well as an additional component unit 8, in turn arranged downstream thereof in the power train and coupled thereto in a torque-transferring manner. The drive unit 5 may also have only one or only two of the stated components 6, 7, 8. The drive motor unit 6 may have an electrical drive motor 6a and a drive motor casing 6b. Also arranged in the drive motor casing 6b are drive motor electronics 6c, which may be a component part of the drive motor unit 6. The intermediate transmission unit 7 may have transmission components 7a and an intermediate transmission casing 7b. The additional component unit 8 may have at least one additional component 8a and an additional component casing 8b. The additional component unit 8 may be an overload-coupling and/or braking unit, in the case of which the respective additional component 8a may be formed by an overload coupling and/or a brake.

As FIGS. 3 and 4 show, arranged one behind the other in the axial direction X, are first the spindle-side drive connection 14a, then the drive motor unit 6, then the intermediate transmission unit 7, then the additional component unit 8, then the coupling arrangement 11 with the spindle 10a arranged thereon and then the torsion tube 16, all of these components being axially secured with respect to the spindle-side drive connection 14a. The torsion tube 16 has in this case on its side facing the drive unit 5 a connection 16a, here in the form of a radial widening, which may be mounted together with the drive unit 5 in the drive unit casing 9. The individual components may be connected to one another in a torque-transferring manner respectively by way of couplings, here claw couplings, reference in this respect being made here only by way of example to the coupling piece 11a of the coupling arrangement 11 (FIG. 3), which may form a first interface and may be coupled in a rotationally secured manner to a corresponding coupling counter-piece (not represented) of the additional component 8a, which may form a corresponding, second interface. It should be pointed out that the previously described sequence of the individual components that are axially secured with respect to the spindle-side drive connection 14a (drive motor unit 6, intermediate transmission unit 7, additional component unit 8, torsion tube 16) is only given by way of example and may well also be different.

The spindle drive 1 may have a tubular casing part 18 rotationally secured with respect to the spindle-side drive connection 14a, here and may be formed by the drive unit casing 9, which extends along the spindle axis A and coaxially thereto and may form a receptacle for at least one of the stated components 6, 7, 8, 16 arranged one behind the other in the axial direction X. “Tubular” means that the casing part 18 is an elongate hollow body with any desired cross section. In particular, it may be a hollow body with a circular cross section.

In the mounted state of the spindle drive 1, the at least one component 6, 7, 8, 16 may be inserted in the tubular casing part 18, in an interlocking manner with respect to the circumferential direction. In the case of the exemplary embodiment described here, the drive motor unit 6, the intermediate transmission unit 7, the additional component unit 8 and the torsion tube 16 may be inserted in the drive unit casing 9 forming the tubular casing part 18 in an interlocking manner with respect to the circumferential direction. It should be pointed out that the torsion tube 16 may be arranged in a certain portion, specifically with its upper connection 16a, within the tubular casing part 18 or drive unit casing 9, which in FIG. 4 is illustrated for the mounted state. Within the torsion tube 16 there then runs the spindle 10a, secured in the axial direction X by way of an axial securing element 19 and mounted rotatably by way of the bearing arrangement 12. Such an interlocking connection between the tubular casing part 18 and the respective component 6, 7, 8, 16 has the advantage that a rotating movement of the components with respect to the tubular casing part 18 receiving them may be limited, and prevented. Here, the respective casings 6b, 7b, 8b as well as the connection 16a of the torsion tube 16 may be held in an interlocking manner in the circumferential direction in the interior of the tubular casing part 18. Here, the interlocking engagement may prevent twisting between the respective component 6, 7, 8, 16 and the casing part 18, and also may prevent twisting between components 6, 7, 8, 16 respectively adjacent to one another in the axial direction X. In this way, drive backlash can be reduced since there is a change in the direction of rotation of the spindle drive 1, the individual components as a whole and their casings do not move at the same time. This also improves the acoustics and provides a more rigid transfer of the drive torque.

The interlocking engagement in the circumferential direction, which may be provided in both circumferential directions, and otherwise may also optionally be provided in the axial direction X, may be provided in various ways. Thus, for the interlocking engagement, for example at least one formation 20 in the tubular casing part 18 or the drive unit casing 9 is in engagement with an assigned counter-formation 21 on the respective component 6, 7, 8, 16. The formation 20 may in each case be a radial projection and the assigned counter-formation 21 may be a radial depression, or vice versa.

In the case of the exemplary embodiment represented here, provided as the formation 20 in the tubular casing part 18 may be a radially inwardly facing bead 22, which in principle may also be formed by a radially inwardly facing bulge (not represented). The respective component 6, 7, 8, 16, which may be held in an interlocking manner in the circumferential direction, has for example as the assigned counter-formation 21 in each case a groove 23. The formation 20 or bead 22 as well as the counter-formation 21 or groove 23 may have a longitudinal extent that may run completely in the axial direction X.

For example, for the interlocking connection, a number of formations 20 or beads 22 and/or assigned counter-formations 21 or grooves 23, for example three, may be spaced apart from one another in the circumferential direction, here at regular intervals. In this case, the tubular casing part 18 or the drive unit casing 9 has in an upper casing portion 18a with a greater cross section different formations 20 or beads 22 than in a lower casing portion 18b with a smaller cross section. The formations 20 or beads 22 in the upper casing portion 18a may serve for holding the drive motor unit 6 and the intermediate gear unit 7 in an interlocking manner in the circumferential direction, whereas the formations 20 or beads 22 in the lower casing portion 18b may serve for holding the additional component unit 8 of the torsion tube 16 in an interlocking manner in the circumferential direction.

The respective formation 20 and/or counter-formation 21 may be an embossed formation, which for example has been produced after the insertion of the respective component 6, 7, 8, 16 into the tubular casing part 18. In principle, the production of such an embossed formation may also be performed before the insertion. However, if the respective component 6, 7, 8, 16 is first inserted into the tubular casing part 18, and coupled in a torque-transferring manner to the component respectively adjacent in the axial direction X, and then the embossing formations are produced at the same time in one and the same embossing operation. In this way, a rotationally secured, i.e. backlash-free, interlocking connection can be created.

It is also conceivable to connect a separate molded body (not represented here) to the tubular casing part 18, the respective formation 20 may be formed by the separate molded body or a component part of the separate molded body. The separate molded body may consist of a single inlay in the form of a bulge or of a peripheral insert, which may be provided with corresponding beads or bulges. Such a molded body may be connected on the inner side to the tubular casing part 18 in a material-bonding manner, for example by adhesive bonding.

It is similarly conceivable to provide for the interlocking engagement a tubular casing part 18, which has in cross section an unround, or angular, inner contour, the respective component 6, 7, 8, 16 additionally or alternatively having in cross section an unround, or angular, outer contour.

The previously described hold in the circumferential direction, produced by the interlocking engagement, may be additionally supported by the respective component 6, 7, 8, 16 also being connected to the tubular casing part 18 in a material-bonding and/or frictional manner. It is also conceivable, if the number of components 6, 7, 8, 16 as described above are to be fixed in the circumferential direction, to insert only some of the components into the tubular casing part 18 in an interlocking manner in the circumferential direction in the way described above and not to fix other components on the tubular casing part 18 at all, or in some other way, for example by material bonding and/or frictional engagement.

In the case of the spindle drive 1, the components 6, 7, 8, 16 respectively inserted in the tubular casing part 18 in an interlocking manner may be in contact with the tubular casing part 18 directly, it also being possible here however for a damping material to be provided (not represented here), in the region of the interlocking engagement, between the respective component 6, 7, 8, 16 and the tubular casing part 18. The components 6, 7, 8, 16 and the tubular casing part 18, for example, consist of the same material, specifically a metal or plastic, at least in the contact region (region where contact is made).

The previously described construction of the spindle drive 1, and in particular the interlocking engagement provided with respect to the circumferential direction, allows the spindle drive 1 to be assembled particularly easily. The components 6, 7, 8, 16 adjacent to one another in the axial direction X only have to be fitted together axially, whereby a torque-transferring coupling is automatically formed. In this state, for example, two of the components 6, 7, 8 respectively adjacent to one another in the axial direction X make contact with one another, not only by way of their interfaces coupled to one another in a torque-transferring manner, but also at their end faces by way of their respective casings 6b, 7b, 8b, while here also the connection 16a of the torsion tube 16 makes contact with the end face of the additional component casing 8b and/or the spindle-side drive connection 14a is connected to the drive motor casing 6b, in an axially secured and/or rotationally secured manner.

In the case of the exemplary embodiment described here as a spindle drive 1, as already explained, the tubular casing part 18 may be formed by the drive unit casing 9 of the drive unit 5. However, also conceivable in principle are variants of a spindle drive 1 in which a torsion tube 16 as previously defined of the spindle drive 1 and/or an input tube 17a as previously defined of the casing 17 of the spindle drive 1 may additionally or alternatively be provided as the tubular casing part 18. Also in the latter cases, it is possible with a suitable construction to connect one or more components of the spindle drive 1 to the respective tubular casing part 18 in an interlocking manner with respect to the circumferential direction.

According to a further teaching is a closure element arrangement 2 of a motor vehicle 4 which may have a closure element 3 adjustably coupled to the body of the motor vehicle 4 and at least one spindle drive 1 of the type described above. Two spindle drives 1 of the type described above are provided, each arranged on one side of the closure element 3.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

1 spindle drive

2 closure arrangement

3 closure element

4 motor vehicle

5 drive unit

6 drive motor unit

6a electrical drive motor

6b drive motor casing

6c drive motor electronics

7 intermediate transmission unit

7a transmission components

7b intermediate transmission casing

8 additional component unit

8a additional component

8b additional component casing

9 drive unit casing

10 spindle/spindle nut transmission

10a rotating spindle

10b spindle nut

11 coupling arrangement

11a coupling piece

12 bearing arrangement

13 power train

14a spindle-side drive connection

14b spindle-nut side drive connection

15 spindle guide tube

16 torsion tube

16a connection

17 casing

17a input tube

17b output tube

18 tubular casing part

18a upper casing portion

18b lower casing portion

19 axial securing element

20 formation

21 counter formation

22 bead

23 groove

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A spindle drive for a closure element of a motor vehicle, comprising:
a power-train configured with a drive unit, and a spindle/spindle nut transmission having a spindle and a spindle nut arranged downstream of the drive unit,
the power-train having a geometrical spindle axis configured in an axial direction of the powertrain, the power-train configured to move linearly between a spindle-side drive connection configured at a first end of the power-train and a spindle-nut-side drive connection configured at a second and opposite end of the power-train relative to the first end,
a tubular casing part configured between the spindle-side drive connection and the spindle-nut-side drive connection, the tubular casing configured to extend along the spindle axis, the tubular casing part forming a receptacle, wherein the receptacle is configured to receive the drive unit, the drive unit having at least one of a drive motor unit, an intermediate transmission, an additional component and a torsion tube, the at least one of the drive motor unit, the intermediate transmission, the additional component and the torsion tube are arranged one behind the other in the axial direction and are axially secured with respect to the spindle-side drive connection within the tubular casing part, such that when mounted in the tubular casing part of the spindle drive, the at least one of the drive motor unit, the intermediate transmission, the additional component and the torsion tube are in interlocking engagement with respect to a circumferential direction.

2. The spindle drive of claim 1, wherein the interlocking engagement is configured to prevent twisting between the at least one of the drive motor unit, the intermediate transmission, the additional component, the torsion tube and the tubular casing part when each are configured adjacent to one another in the axial direction.

3. The spindle drive of claim 1, wherein the interlocking engagement is with respect to at least one of the circumferential direction and the axial direction.

4. The spindle drive of claim 2, wherein at least one formation is configured at least one of in and on the tubular casing part and an assigned counter-formation is configured at least one of in and on the at least one of the drive motor unit, the intermediate transmission, the additional component and the torsion tube to create the interlocking engagement between the at least one of the drive motor unit, the intermediate transmission, the additional component and the torsion tube and the tubular casing part.

5. The spindle drive of claim 4, wherein the formation in the tubular casing part is at least one of a radially inwardly facing, bulge and a radially inwardly facing bead.

6. The spindle drive of claim 4, wherein a plurality of the formations and a plurality of the assigned counter-formations are configured in the circumferential direction and spaced apart from one another at regular intervals.

7. The spindle drive of claim 4, wherein the at least one of the formation an the counter-formation is embossed on the at least one of the drive motor unit, the intermediate transmission, the additional component, the torsion tube and the tubular casing at least one of before and after the insertion of the at least one of the drive motor unit, the intermediate transmission, the additional component and the torsion tube into the tubular casing part, and wherein the embossing is configured simultaneously on the at least one of the drive motor unit, the intermediate transmission, the additional component, the torsion tube and the tubular casing.

8. The spindle drive of claim 4, wherein the formation is at least one of a separate molded body and a separate component part of a separate molded body, which is connected to the tubular casing part in at least one of a rotationally secured manner and a material-bonding manner, and wherein the molded body is connected to the tubular casing part on an inside radial surface.

9. The spindle drive of claim 1, wherein the tubular casing part has at least one of an unround and angular inner contour cross section, and wherein the at least one of the drive motor unit, the intermediate transmission, the additional component and the torsion tube has at least one of an unround and angular outer contour.

10. The spindle drive of claim 1, wherein the at least one of the drive motor unit, the intermediate transmission, the additional component and the torsion tube is at least one of material-bonded and friction bonded to the tubular casing part.

11. The spindle drive of claim 1, wherein the at least one of the drive motor unit, the intermediate transmission, the additional component, the torsion tube and the tubular casing part are configured of the same material in a contact region and a damping material arranged between the at least one of the drive motor unit, the intermediate transmission, the additional component and the torsion tube when inserted and interlocked in the tubular casing part.

12. The spindle drive of claim 1, wherein the at least three of the drive motor unit, the intermediate transmission, the additional component and the torsion tube are mounted within the tubular casing part are only coupled to one another in a rotationally secured manner indirectly by an inner surface of the tubular casing part.

13. The spindle drive of claim 1, wherein the the drive motor unit is configured with a drive motor and a drive motor casing, the intermediate transmission unit is configured with transmission components and an intermediate transmission casing, the additional component unit is configured with at least one additional component and an additional component casing, and a torque-transferring coupling arrangement is arranged at the input-side end of the spindle, and wherein the drive motor unit, the intermediate transmission unit, the additional component unit and the coupling arrangement are inserted in the tubular casing part and interlocked together with respect to the circumferential direction.

14. The spindle drive of claim 1, further comprising a drive unit casing, the drive unit casing houses the drive unit the torsion tube and an input tube, the driving unit casing forming the tubular casing part.

15. (canceled)

16. The spindle drive of claim 4, wherein the at least one formation is at least one of a radial projection and radial depression and the assigned counter-formation is at least one of a radial depression and a radial projection, and wherein the counter-formation in the tubular casing part is at least one of a groove, a bulge and a bead, the groove having at least a portion extending longitudinally in the axial direction.

17. A spindle drive closure element of a motor vehicle, comprising:
a powertrain having a drive unit interconnected to a spindle/spindle nut transmission, the spindle nut transmission including a spindle and a spindle nut configured along a spindle axis extending longitudinally through a center of the powertrain, the powertrain is configured to move linearly between a first end and a second and opposite end,
a tubular casing configured and interconnected between the first end at a spindle-side drive connection and the second and opposite end at a spindle-nut-side drive connection, the tubular casing configured to extend longitudinally along the spindle axis, the tubular casing is configured to receive at least two of a drive motor unit, an intermediate transmission, an additional component and a torsion tube, the at least one of the drive motor unit, the intermediate transmission, the additional component and the torsion tube are arranged axially one behind the other are secured with respect to the spindle-side drive connection such that when mounted in the tubular casing, the at least one of the drive motor unit, the intermediate transmission, the additional component and the torsion tube are in interlocking engagement with respect to a circumferential direction.

18. The spindle drive of claim 17, wherein the interlocking engagement is configured to prevent twisting between the at least one of the drive motor unit, the intermediate transmission, the additional component, the torsion tube and the tubular casing when each are configured adjacent to one another in the axial direction.

19. A closure element powertrain for a motor vehicle, comprising:
a drive unit configured in a first tubular casing,
a spindle/spindle nut transmission, the spindle nut transmission including a rotating spindle and a spindle nut configured in a second tubular casing, the first tubular casing and the second tubular casing are coupled together at a coupling piece and configured telescopically to retract and extend along a spindle axis, the spindle axis extending longitudinally through a center line of the powertrain,
at least one of the drive unit and the spindle/spindle nut transmission is configured to move linearly between a first end configured on an outer surface of the first tubular casing and a second and opposite end configured on an outer surface of the second tubular casing,
the tubular casing is configured to receive at least one of a drive motor unit, an intermediate transmission, an additional component and a torsion tube, the at least one of the drive motor unit, the intermediate transmission, the additional component and the torsion tube are arranged axially one behind the other within at least one of the first tubular casing and the second tubular casing, and are interlocked together with respect to a circumferential direction.

20. The closure element powertrain of claim 19, wherein at least one formation is configured at least one of in and on the tubular casing part and an assigned counter-formation is configured at least one of in and on the at least one of the drive motor unit, the intermediate transmission, the additional component and the torsion tube to create the interlocking engagement between the at least one of the drive motor unit, the intermediate transmission, the additional component and the torsion tube and the tubular casing part.

21. The closure element powertrain of claim 20, wherein the at least one formation is at least one of a radially inwardly facing, bulge a radially inwardly facing bead.
